(19) United States
(12) Patent Application Publication
(10) Pub. No.: US 2005/0277105 A1
(43) Pub. Date: Dec. 15, 2005

(54) System and method for training personnel

(75) Inventor: Daniel James Chickvara, Duluth, GA (US)

Correspondence Address: BANNER & WITCOFF, 1001 G STREET N W, SUITE 1100, WASHINGTON, DC, 20001, US

(73) Assignee: Unisource Worldwide, Inc., Norcross, GA (US)

(21) Appl. No.: 10/847,340

(22) Filed: May 18, 2004

(51) Int. Cl. G09B 19/00

(52) U.S. Cl. 434/369

(57) ABSTRACT

System and method for training workplace personnel is disclosed. Labels having indicia corresponding to frequency with which predefined maintenance procedures are to be performed may be attached to various locations around an establishment premises to identify the area needing service and the required frequency of that service. Storage unit may be wall-mounted to store instructions on procedures. Tracker may be used to check off, and keep track of, accomplishment of required maintenance procedures. Labels and instructions may be packaged as a training kit for distribution and use.

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

The present inventions relate generally to the area of workplace training. Specifically, aspects of the present inventions relate to systems and methods for instructing employees as to the frequency and manner of performing various maintenance procedures.

### BACKGROUND OF THE INVENTION

Would you buy food from a dirty supermarket or eat at a restaurant whose ovens keep breaking down? Few of us would, and for that reason it is vitally important to supermarket and restaurant owners to make sure that their establishments are as clean as possible, and that their equipment is kept in tip-top shape. Unfortunately, there are a number of obstacles that make this a very difficult task.

For starters, equipment is getting more and more sophisticated, and more and more difficult to clean and maintain. Upright freezers, computer-controlled ovens, soda fountains, soup kettles, deep fryers, and a host of other gizmos and gadgets each come with their own complicated set of maintenance and cleaning instructions. An employee may have to learn a dozen unique steps just to clean one of these items, and it may take months of on-the-job training before a new employee has mastered the art of keeping everything clean and operational. These are months of valuable employee time that are lost just getting up to speed.

To make matters worse, many of the cleaning and maintenance procedures have to be performed at different frequencies. Some tasks might have to be done daily, others weekly or monthly, and yet others may need to be done continuously. It is difficult for a team of workers to fully keep track of what's been done, what needs to be done, and how often things need to be done. As a result, things can easily slip through the cracks.

Employee turnover rates don't help the situation, either. Just when a team has mastered the art of keeping things running, it may lose experienced employees. More time must then be spent training the new replacements, repeating the loss of valuable employee time to training, and further increasing the likelihood of mistakes.

What can be done? Well, what's needed is a better, and faster, way to train employees on how to take care of the business. There is also a need for a simple way for a team of employees to keep track of how frequently tasks need to be done, and when the last time that task was done. Such an improved training process would significantly improve the efficiency of any business that depends on well-trained employees.

### BRIEF SUMMARY OF THE INVENTION

This patent provides a number of inventions and concepts that will help keep a business running smoothly and cleanly. In one aspect, a number of easily-identifiable labels, such as stickers, are created. Each label has a unique color corresponding to a frequency (e.g., monthly, weekly, daily, etc.), and the labels are placed at locations where something needs to be done. A set of color-coded instruction manuals may be placed throughout the business establishment, where the color of the manuals matches the color of a label. Such a match may tell employees how often the procedures in the manual need to be performed, and the sticker location identifies the location needing the work.

Another aspect provides a centralized location for the various color-coded manuals. In some further aspects, a wall-mounted, staggered display may be used to keep the manuals easily-accessible.

A further aspect provides a procedure tracker, a color-coded visual tool that helps employees keep track of when procedures need to be performed, and to identify tasks that have already been completed.

In a further aspect, training kits may be assembled, containing the labels and maintenance procedures.

### BRIEF DESCRIPTION OF THE DRAWINGS

A more complete understanding of the present invention and the advantages thereof may be acquired by referring to the following description in consideration of the accompanying drawings, in which like reference numbers indicate like features, and wherein:

FIG. 1 illustrates an example label according to one embodiment of an invention of the applicant as disclosed herein.

FIG. 2 illustrates an example label according to a second embodiment of an invention of the applicant as disclosed herein.

FIG. 3 illustrates an example instruction manual according to an embodiment of an invention of the applicant as disclosed herein.

FIGS. 4a and 4b illustrate an example of a wall-mounted storage area for instruction manuals, according to an embodiment of an invention of the applicant as disclosed herein.

FIG. 5 illustrates an example of a placard according to an embodiment of an invention of the applicant as disclosed herein.

FIG. 6 illustrates an example of a procedure tracker/accountability sheet according to an embodiment of an invention of the applicant as disclosed herein.

FIG. 7 illustrates an example of a sheet of labels according to one embodiment.

FIG. 8 illustrates an example of an instruction sheet for a maintenance procedure according to one embodiment.

FIG. 9 illustrates an example process of using an embodiment of applicant's training system to streamline the process of training employees in the frequency of performing maintenance procedures.

FIGS. 10 and 11 illustrate further examples of a procedure tracker/accountability sheet that may be used.

### DETAILED DESCRIPTION OF THE INVENTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

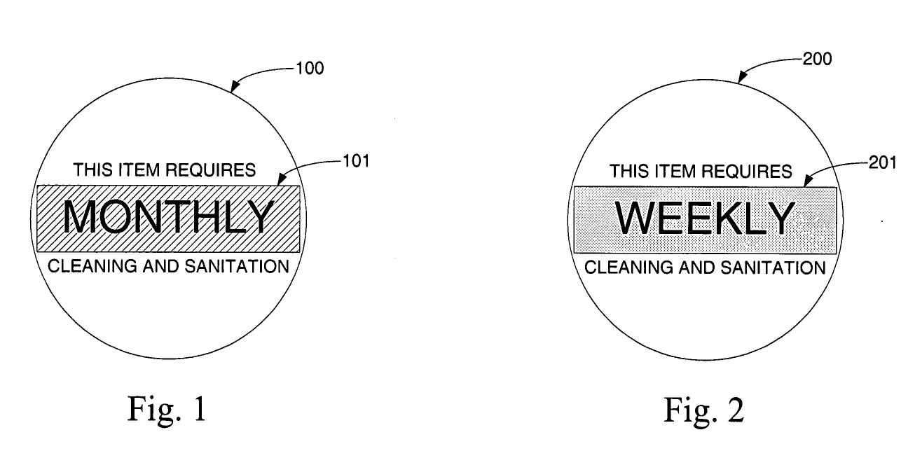

FIG. 1 illustrates an example label according to one embodiment of an invention disclosed herein. The label 100 may be an adhesive-backed sticker, a pressure-sensitive sticker, a magnetic sign, or any other kind of attachable logo or sign. The label 100 may also be made of any material, such as paper, cardboard, plastic, metal, etc., and may also have a wear surface for durability. For example, the label 100 may be laminated, vinyl coated, or may have a protective layer of glass, plexiglass or other protective coating.

The label 100 may include indicia 101. Indicia 101 may be a color (e.g., blue, green, yellow, etc.). In alternative embodiments, the indicia 101 may include a pattern, such as shading or a pattern of lines. Indicia 101 may correspond to a predetermined frequency for performing a task. For example, the indicia 101 shown in FIG. 1 corresponds to tasks that are to be completed on a monthly basis. The frequency can be any period of time or time interval, including, but not limited to, yearly, seasonal, monthly, weekly, daily, hourly, and continuously, and may alternatively be expressed as a number of occurrences per unit time (such as twice per month, once per day, twelve times per year, etc.). The use of colors and/or patterns to make this identification may be advantageous in that the employee's spoken language and literacy may be rendered irrelevant in identifying the tasks that need performance. In such embodiments, a common set of indicia may be used for all literacy levels and language fluencies.

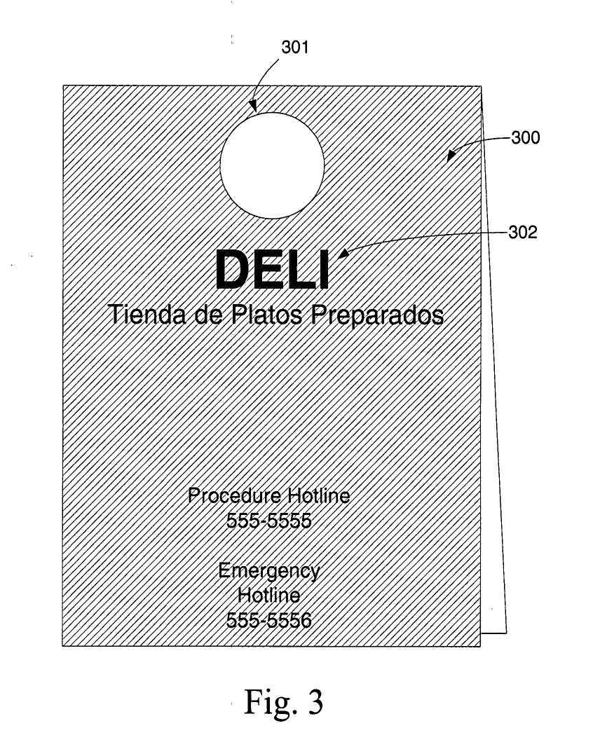

FIG. 2 illustrates a second label 200 having a different indicia 201 from the one shown in FIG. 1. Indicia 201 may be a different color or pattern from indicia 101, and may be associated with a different frequency (e.g., weekly).

The labels 100, 200 may be used as part of an employee training system to quickly and easily identify areas in an establishment (e.g., restaurant, supermarket, retail store, office, or any other kind of location in which employees may work) that need attention, and the frequency with which they need that attention. The labels 100, 200 may be attached to surfaces or areas such as machinery, doors, rooms, walls, etc. A supermarket butcher may have separate labels on the door of a meat locker, the cutting surface, cutting machinery, and refrigerated display case to signify when those locations and items need some form of maintenance procedure (e.g., service, repair, cleaning, maintenance, inspection, or any other kind of attention). Label 100 may be placed on the door of a meat locker that requires monthly cleaning, while label 200 may be placed on a surface of a refrigerated display case that requires weekly cleaning. By having such labels prominently displayed throughout the establishment, employees may easily identify how frequently certain maintenance procedures will need to be performed, and the locations where they need to be performed. If such labels are easily seen by customers, that may instill confidence among the customers that the establishment is diligently maintaining its cleanliness.

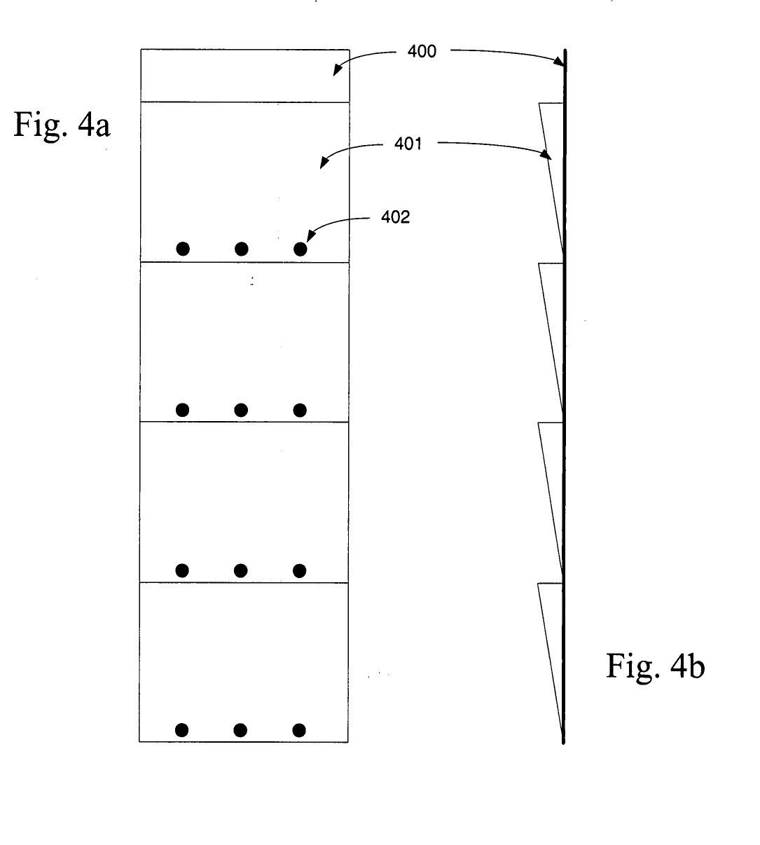

To further simplify training, a number of instruction sources may be provided as a resource for employees who are preparing to perform a required maintenance procedure. An instruction source may be a printed or electronic textual form, such as a document, manual, instruction sheet, book, binder, or any other form of viewable media. In some embodiments, the instruction source may collect instructions for maintenance procedures that share a common frequency of performance. For example, FIG. 3 illustrates an example instruction source 300. The instruction source 300 may be a bound collection of sheets containing instructions for performing various maintenance procedures. The sheets may be spiral-bound at the top edge to allow ease of use. A face of the instruction source 300 may bear an indicia 301 corresponding to an indicia 101, 201 appearing on labels 100, 200 to allow the employee to easily identify which group of maintenance procedures is contained therein. To further simplify its use, the face or cover of the instruction source 300 may repeat the indicia 101, 201, or an aspect of it. For example, the instruction source 300 may have its entire front face or cover printed in the color of the indicia 101, thereby signifying that the maintenance procedures contained inside are to be performed at the frequency associated with the color of indicia 101 (in the example, monthly).

In some embodiments, the instruction source 300 is a bilingual printed manual, such that instructions in one language are found on one side of a page, while the same instructions are found on the other side of the page in a second language. Such a manual may be bound as a “flip” book for ease of use.

Since an establishment may have multiple different departments, each such department may choose to implement its own set of labels and maintenance procedures. The instruction source 300 may include an identifier 302 of the particular department to which the source belongs. In the FIG. 3 example, the source 300 contains the instructions for monthly maintenance procedures in the deli department.

The instruction source 300 may be protected from wear, use, and exposure to harmful elements (e.g., grease, water, soap, etc.) in a variety of known methods. The pages of instructions may be laminated or coated with a protective surface such as glass, plexiglass, etc. Alternatively, the instruction source 300 may be printed on durable plastic or metal.

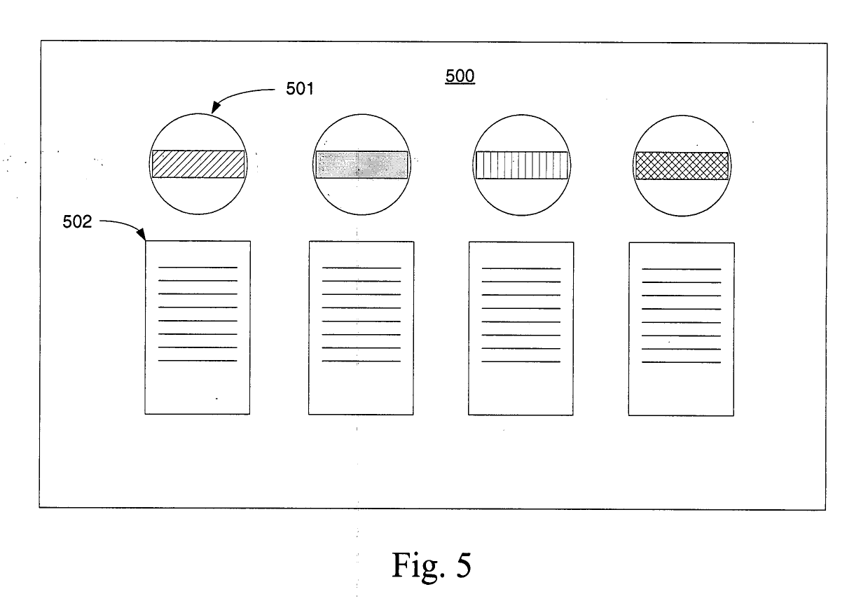

For ease of access, the various instruction sources 300 may be stored in a storage unit, such as the one depicted in FIGS. 4a (front) and 4b (profile). Storage unit 400 may be constructed of any durable material, such as plastic or acrylic, and may have a number of staggered pockets 401 to allow a portion of each source 300 to remain visible and easily retrievable. In some embodiments, the pockets may include drainage holes 402 to prevent undesired accumulation of water and other contaminants, and to allow the unit to remain in place during water cleaning.

In some embodiments, storage unit 400 is mounted on a wall using, for example, self-adhesive Velcro strips, nails, crews, picture hanging devices, or other known types of hanging structures. In other embodiments, the storage unit 400 may be a free-standing display.

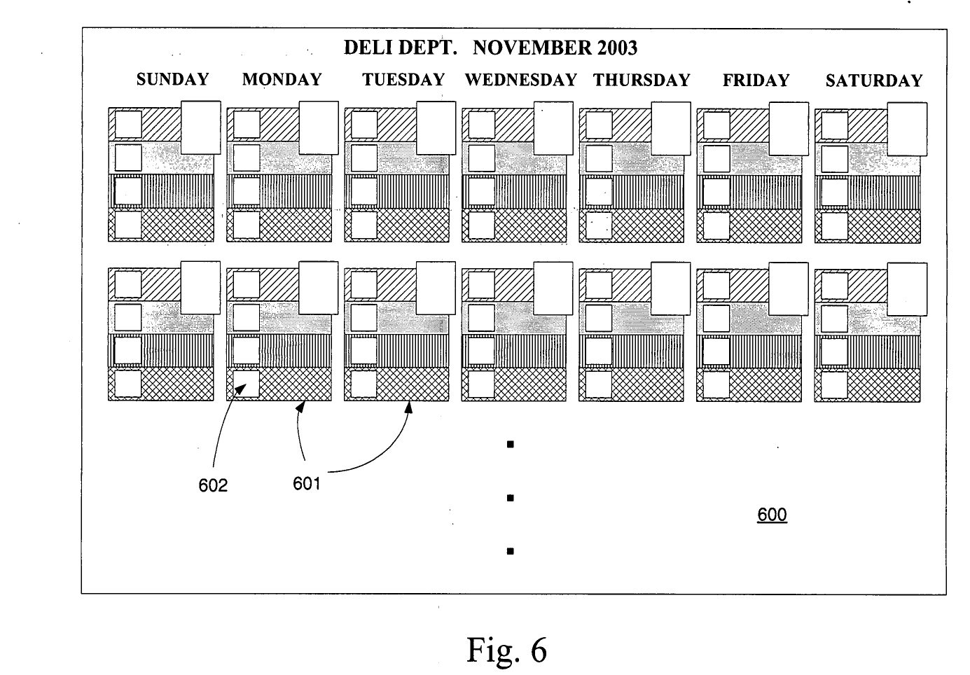

FIG. 5 illustrates a placard 500 that may be displayed to allow employees to quickly see the list of maintenance procedures that are to be performed, and their corresponding frequencies of performance. In the FIG. 5 example, the various indicia 501 are displayed, and under each indicia 501 is a listing 502 of the maintenance procedures that are to be performed at the frequency associated with the indicia. As with the instruction source 300 and labels, placard 500 may also be protected from wear and use through lamination or other coating, or through printing on a durable surface such as plastic or metal. Placard 500 may be mounted on a wall, affixed to a surface, displayed on a computer screen, or otherwise displayed for employees to view.

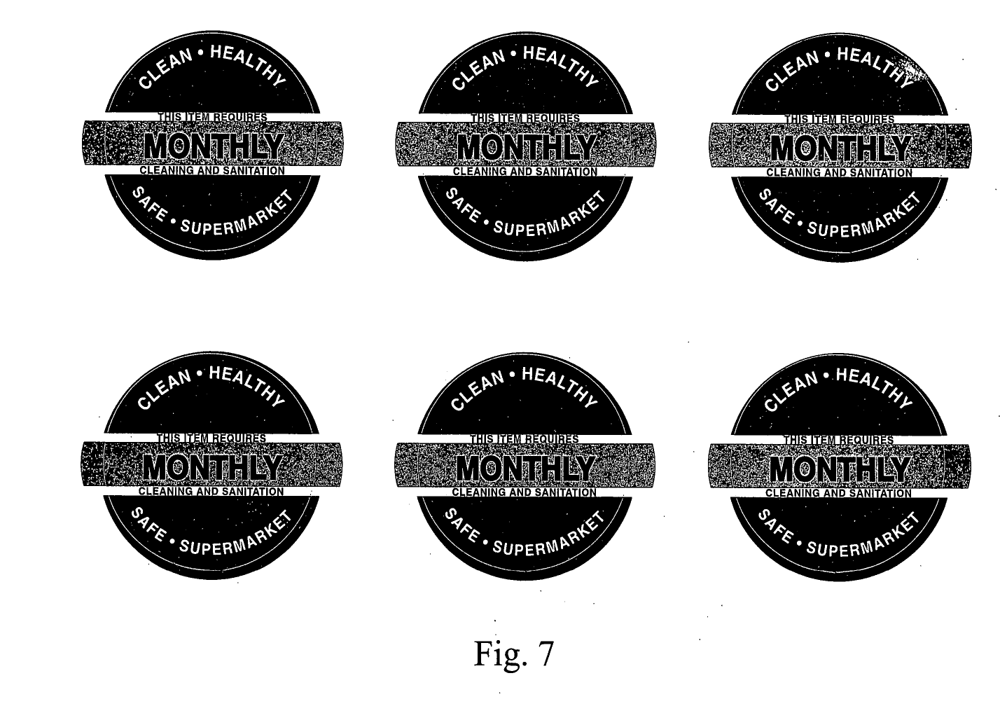

FIG. 6 illustrates an example procedure tracker (or accountability sheet) 600 that may be used to help employees keep track of the performance of the various maintenance procedures. In the FIG. 6 example, a number of indicia groups 601 are displayed corresponding to a time period (e.g., a calendar month, a number of weeks, etc.). Within each indicia group 601 are the various label indicia, with checkboxes 602 to indicate when a particular task has been performed within that time period. The tracker 600 may be arranged in a calendar-type display for ease of use. In use, a department manager or sub-contractor may use tracker 600 to ensure that all required monthly, weekly, and daily procedures are performed according to schedule.

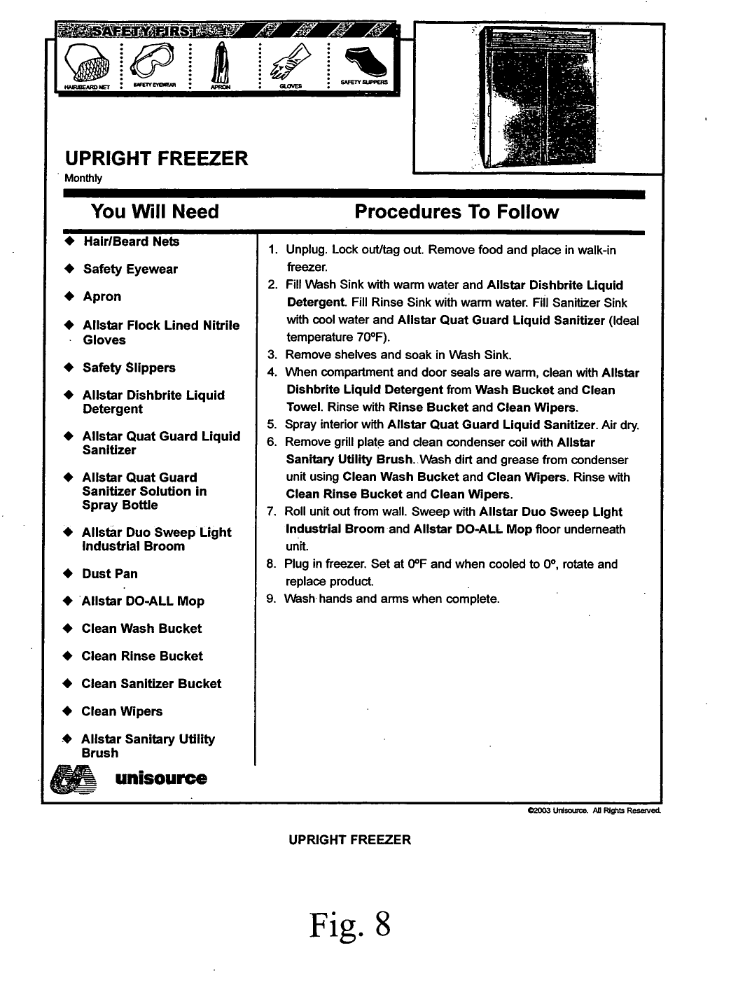

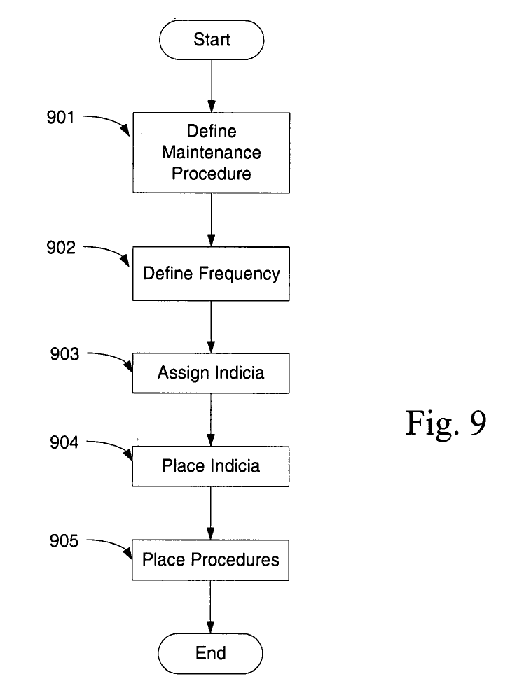

Applicant's novel system of training may be embodied as a training kit, containing an assortment of the instruction sources and labels described above, and may optionally include the additional elements described above. FIG. 7 illustrates an example sheet of labels that may be included in such a kit, and FIG. 8 illustrates an example instruction sheet for the monthly cleaning of an upright freezer.

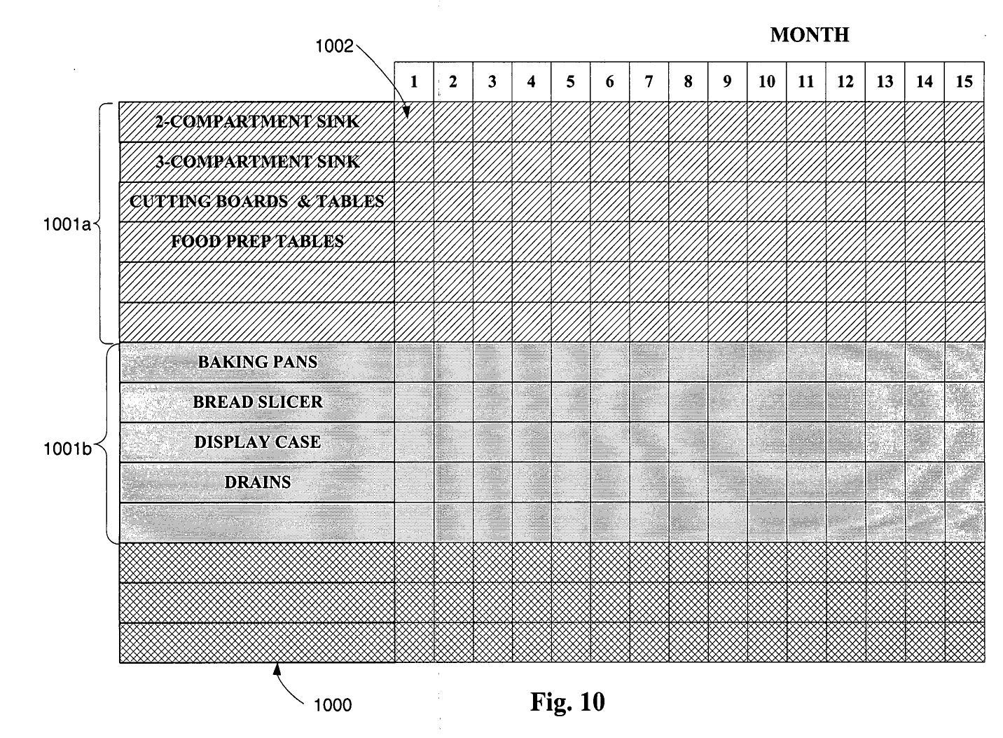

FIG. 9 illustrates an example process of implementing applicant's training system. Beginning in step 901, the various maintenance procedures will need to be defined. This may be, for example, in the form of instructions shown in FIG. 8, although other forms of instructions may be used. Once the various procedures themselves are defined, they will be provided in step 902 with a frequency (or time period) with which they should be performed. For example, some procedures will need to be performed monthly, while others may need to be performed daily. These first two steps may be provided by the establishment owner, or they may be provided by the makers of the various pieces of equipment being cleaned and maintained.

Once the various procedures have been defined and given a frequency of performance, they are assigned to a corresponding indicia in step 903. For example, the indicia color blue may be assigned to tasks that need to occur monthly.

When the various indicia have been assigned, their corresponding labels may then be attached or placed, in step 904, at the various locations around the establishment. Machinery, walls, floors, etc. may have a label and indicia placed on them to indicate the need for service and the required frequency of service.

In step 905, the various instruction sources explaining the procedures may be placed at a suitable location for employee access, such as in a wall-mounted storage unit described above.

While the various steps in the FIG. 9 example are shown in a particular order, the steps need not occur in that order. For example, the procedure frequency may be defined prior to the definition of the procedure; or the procedures may be placed prior to placing the indicia labels.

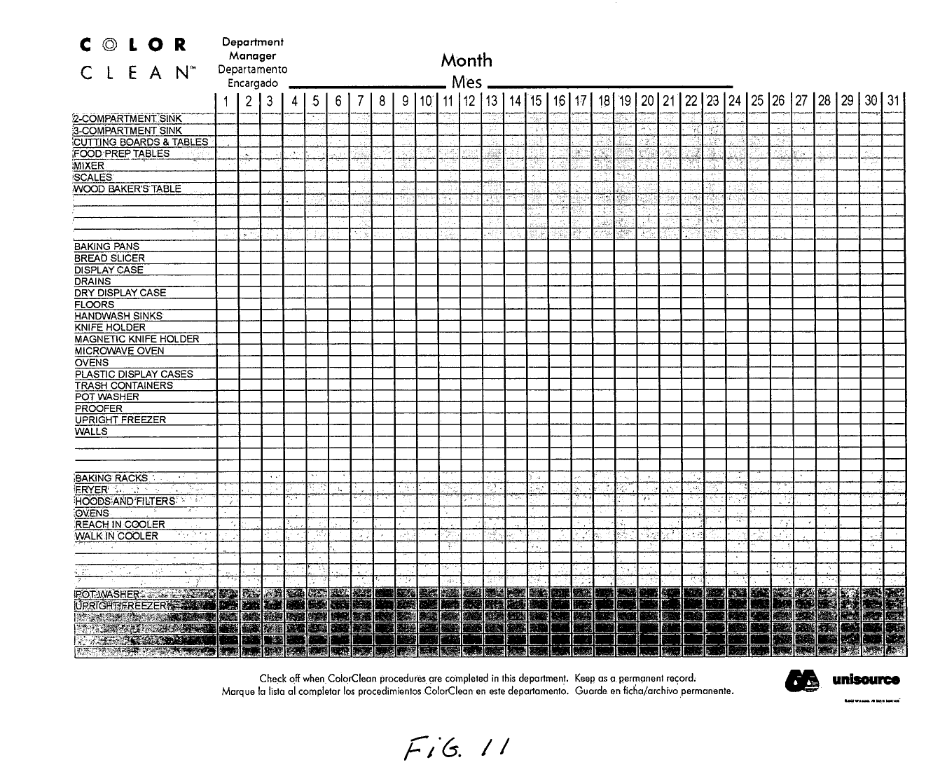

FIG. 10 depicts another example embodiment of a procedure tracker/accountability sheet 1000, which is similar to the one shown in FIG. 6. In the FIG. 10 example, a schedule (the first fifteen days of the month are shown in the figure) is provided with a plurality of sections 1001a, 1001b, which may be coded with the indicia corresponding to predetermined frequencies/time periods. For example, the various tasks listed in section 100a might have the indicia corresponding to tasks that require daily performance, while section 1001b might have indicia corresponding to tasks that require weekly performance. Having the indicia throughout the section helps delineate the listed tasks. The individual cells 1002 in the sections may be checked off (e.g., marked, signed, initialed, etc.) to indicate that the required task has been completed, and on the day of completion. The manner of checking off may include an identification (such as initials) of the person responsible for accomplishing the task, so that accountability may be properly maintained. Although the figure depicts a portion of a monthly calendar, any time period and/or calendar format may be used. FIG. 11 depicts an example embodiment of a procedure tracker/accountability sheet, similar to that shown in FIG. 10.

While the invention has been described with respect to specific examples including presently preferred modes of carrying out the invention, those skilled in the art will appreciate that there are numerous variations and permutations of the above described systems and techniques. Thus, the spirit and scope of the invention should be construed broadly as set forth in the appended claims.

1. A training kit, comprising:
a first plurality of attachable labels having a first indicia associated with a first frequency, said attachable labels being configured for attachment to a surface;
a second plurality of attachable labels having a second indicia associated with a second frequency, said attachable labels being configured for attachment to a surface;
a first instruction source containing a first set of instructions for performing a first predefined maintenance procedure, said first predefined maintenance procedure to be performed at said first frequency; and
a second instruction source containing a second set of instructions for performing a second predefined maintenance procedure, said second predefined maintenance procedure to be performed at said second frequency.

2. The training kit of claim 1, further including a display structure, said display structure configured to be mounted on a wall, and having a plurality of staggered pockets for storage of said instruction sources.

3. The training kit of claim 1, further including a procedure tracker, wherein said procedure tracker has a plurality of indicia corresponding to said first and second indicia and to performance of said first and second predefined maintenance procedures over a predetermined period of time.

4. The training kit of claim 3, wherein said first plurality of attachable labels include a pressure-sensitive backing.

5. The training kit of claim 3, wherein said first plurality of attachable labels include an adhesive backing.

6. The training kit of claim 1, wherein said first and second indicia are colors.

7. The training kit of claim 1, wherein said first and second indicia are patterns of lines.

6. The training kit of claim 1, wherein said first instruction source includes said first indicia on a face side; and said second instruction source includes said second indicia on a face side.

7. The training kit of claim 6, wherein said first and second instruction sources are bound and laminated.

8. The training kit of claim 1, further including a wall-mountable placard, said placard listing a plurality of maintenance procedures to be performed at said first frequency in association with said first indicia; and listing a plurality of maintenance procedures to be performed at said second frequency in association with said second indicia.

9. A method of training, comprising the steps of:
preparing a plurality of maintenance procedures to be performed at a plurality of locations within an establishment;
identifying, for each of said plurality of maintenance procedures, a frequency with which said procedures are to be performed;
associating a plurality of indicia with said frequencies, such that each of said frequencies has a corresponding indicia;
attaching a plurality of labels, each having one of said indicia, at said plurality of locations within said establishment; and
providing a textual form for each of said plurality of maintenance procedures, each said textual form having one of said indicia on a face, and placing said textual form at a location within said establishment.

10. The method of claim 9, further comprising the step of providing a maintenance procedure tracker, said tracker having a plurality of said indicia arranged to monitor performance of said plurality of maintenance procedures over a period of time.

11. The method of claim 10, further comprising the step of placing said textual forms of said maintenance procedures in a wall-mounted, staggered storage unit.

12. The method of claim 11, wherein said indicia are colors.

13. The method of claim 11, wherein said indicia are patterns.

14. The method of claim 11, further comprising the step of placing a wall-mounted placard displaying each of said indicia, and identifying one or more maintenance procedures to be performed at the frequency corresponding to each of said indicia.

15. A method of training personnel in cleaning procedures at an establishment, comprising the step of:
attaching a plurality of labels at a plurality of locations within said establishment, each of said labels having a color associated with a frequency with which a cleaning procedure is to be performed, wherein placement of a label at a location signifies that a cleaning procedure is to be performed at that location with a frequency associated with the color of the label; and
providing a plurality of color-coded textual instructions for performing said cleaning procedures, wherein a color of each of said textual instructions corresponds to a color of one or more of said labels.
